(19) United States
(12) Patent Application Publication
(10) Pub. No.: US 2015/0106649 A1
(43) Pub. Date: Apr. 16, 2015

(54) DYNAMIC SCALING OF MEMORY AND BUS FREQUENCIES

(71) Applicant: Qualcomm Innovation Center, Inc., San Diego, CA (US)

(72) Inventor: Saravana Krishnan Kannan, San Diego, CA (US)

(73) Assignee: Qualcomm Innovation Center, Inc., San Diego, CA (US)

(21) Appl. No.: 14/176,268

(22) Filed: Feb. 10, 2014

Related U.S. Application Data
(60) Provisional application No. 61/890,116, filed on Oct. 11, 2013.

(51) Int. Cl. G06F 1/08; G06F 11/30; G06F 12/08; G06F 13/24

(52) U.S. Cl. CPC G06F 1/08; G06F 13/24; G06F 11/3034; G06F 12/0802
USPC 713/501

(57) ABSTRACT

Systems and methods for controlling a frequency of system memory and/or system bus on a computing device are disclosed. The method may include monitoring a number of read/write events occurring in connection with a hardware device during a length of time with a performance counter and calculating an effective data transfer rate based upon the amount of data transferred. The method also includes periodically adjusting a frequency of at least one of the system memory and the system bus based upon the effective data transfer rate and dynamically tuning a threshold number of events that trigger an interrupt based upon a history of the number of read/write events. In addition, the method includes receiving the interrupt from the performance counter when the threshold number of read/write events occurs and adjusting the frequency of at least one of the system memory and the system bus when the interrupt occurs.

### PRIORITY

The present application for patent claims priority to Provisional Application No. 61/890,116 entitled “DYNAMIC SCALING OF MEMORY AND BUS FREQUENCIES” filed Oct. 11, 2013, and assigned to the assignee hereof and hereby expressly incorporated by reference herein.

### BACKGROUND

I. Field of the Disclosure

The technology of the disclosure relates generally to data transfer between hardware devices and system memory constructs via an electronic bus, and more particularly to control of the electronic bus and memory frequencies.

II. Background

Electronic devices, such as mobile phones, personal digital assistants (PDAs), and the like, are commonly manufactured using application specific integrated circuit (ASIC) designs. Developments in achieving high levels of silicon integration have allowed creation of complicated ASICs and field programmable gate array (FPGA) designs. These ASICs and FPGAs may be provided in a single chip to provide a system-on-a-chip (SOC). An SOC provides multiple functioning subsystems on a single semiconductor chip, such as for example, processors, multipliers, caches, and other electronic components. SOCs are particularly useful in portable electronic devices because of their integration of multiple subsystems that can provide multiple features and applications in a single chip. Further, SOCs may allow smaller portable electronic devices by use of a single chip that may otherwise have been provided using multiple chips.

To communicatively interface multiple diverse components or subsystems together within a circuit provided on a chip(s), which may be an SOC as an example, an interconnect communications bus, also referred to herein simply as a bus, is provided. The bus is provided using circuitry, including clocked circuitry, which may include as examples registers, queues, and other circuits to manage communications between the various subsystems. The circuitry in the bus is clocked with one or more clock signals generated from a master clock signal that operates at the desired bus clock frequency(ies) to provide the throughput desired. In addition, system memory (e.g., DDR memory) is also clocked with one or more clock signals to provide a desired level of memory frequency.

In applications where reduced power consumption is desirable, the bus clock frequency and memory clock frequency can be lowered, but lowering the bus and memory clock frequencies lowers performance of the bus and memory, receptively. If lowering the clock frequencies of the bus and memory increases latencies beyond latency requirements or conditions for the subsystems coupled to the bus interconnect, the performance of the subsystem may degrade or fail entirely. Rather than risk degradation or failure, the bus clock and memory clock may be set to higher frequencies to reduce latency and provide performance margin, but providing higher bus and memory clock frequencies consumes more power.

### SUMMARY

Aspects of the present invention may be characterized as a method for controlling memory and/or bus frequency on a computing device. The method includes monitoring a number of read/write events occurring in connection with a hardware device during a length of time with a performance counter and calculating an effective data transfer rate based upon the amount of data transferred. The method also includes periodically adjusting a frequency of at least one of the system memory and the system bus based upon the effective data transfer rate and dynamically tuning a threshold number of events that trigger an interrupt based upon a history of the number of read/write events. In addition, the method includes receiving the interrupt from the performance counter when the threshold number of read/write events occurs and adjusting the frequency of at least one of the system memory and the system bus when the interrupt occurs.

Other aspects may be characterized as a computing device that includes a hardware device, a cache memory coupled to the hardware device, a system memory, and a system bus to couple the system memory to the cache memory. The computing device also includes means for monitoring a number of read/write events occurring in connection with the hardware device during a length of time with a performance counter and means for calculating an effective data transfer rate based upon the amount of data transferred. The computing device also includes means for periodically adjusting a frequency of at least one of the system memory and the system bus based upon the effective data transfer rate and means for dynamically tuning a threshold number of events that trigger an interrupt based upon a history of the number of read/write events. In addition, the computing device includes means for receiving the interrupt from the performance counter when the threshold number of read/write events occurs and means for adjusting the frequency of at least one of the system memory and the system bus when the interrupt occurs.

Yet another aspect may be characterized as a non-transitory, tangible processor readable storage medium, encoded with processor readable instructions to perform a method for controlling frequency of system memory and/or a system bus on a computing device. The method includes monitoring a number of read/write events occurring in connection with a hardware device during a length of time with a performance counter and calculating an effective data transfer rate based upon the amount of data transferred. The method also includes periodically adjusting a frequency of at least one of the system memory and the system bus based upon the effective data transfer rate and dynamically tuning a threshold number of events that trigger an interrupt based upon a history of the number of read/write events. In addition, the method includes receiving the interrupt from the performance counter when the threshold number of read/write events occurs and adjusting the frequency of at least one of the system memory and the system bus when the interrupt occurs.

### BRIEF DESCRIPTION OF THE FIGURES

FIG. 1 is a block diagram that generally depicts functional components of an exemplary embodiment;

FIG. 2 is a block diagram of an exemplary processor-based system that may be utilized in connection with many embodiments;

FIG. 3 is a block diagram depicting another exemplary embodiment; and

FIG. 4 is a flowchart depicting a method that may be traversed in connection with the embodiments disclosed herein.

### DETAILED DESCRIPTION

With reference now to the drawing figures, several exemplary embodiments of the present disclosure are described. The word “exemplary” is used herein to mean “serving as an example, instance, or illustration.” Any embodiment described herein as “exemplary” is not necessarily to be construed as preferred or advantageous over other embodiments.

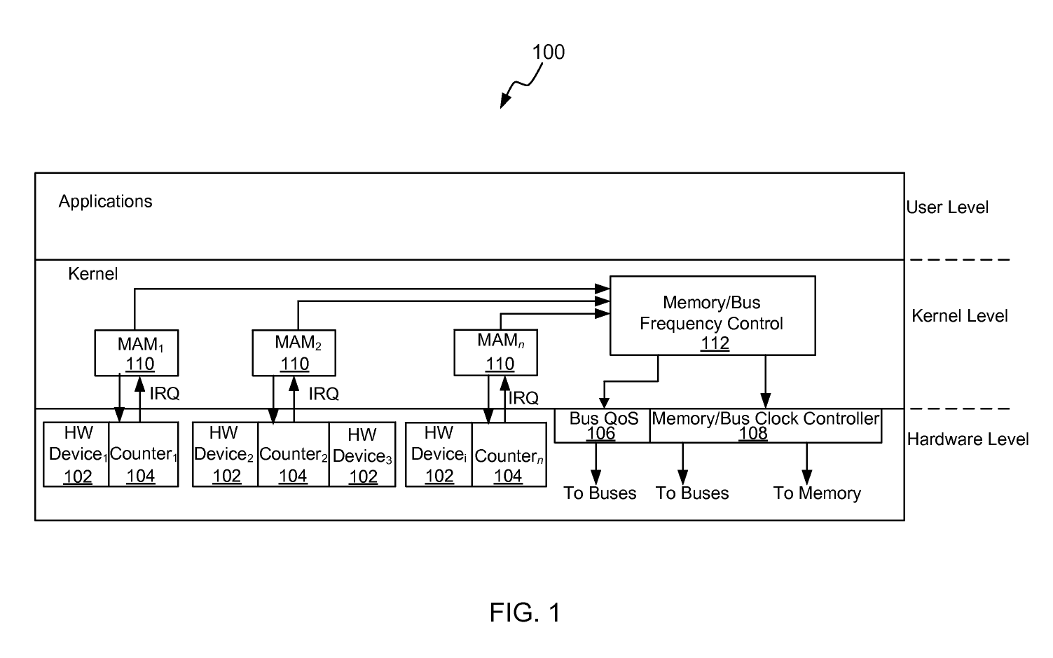

Referring to FIG. 1, shown is a computing device 100 depicted in terms of abstraction layers from hardware to a user level. The computing device 100 may be implemented as any of a variety of different types of devices including smart phones, tablets, netbooks, set top boxes, entertainment units, navigation devices, and personal digital assistants, etc. As depicted, applications at the user level operate above the kernel level, which is disposed between the user level and the hardware level. In general, the applications at the user level enable a user of the computing device 100 to interact with the computing device 100 in a user-friendly manner, and the kernel level provides a platform for the applications to interact with the hardware level.

As depicted, in the hardware level a quantity of i hardware devices 102 (e.g., one or more hardware devices) reside with a quantity of n performance counters 104 (also referred to herein simply as counters). In general, each of the hardware devices 102 is capable of reading and/or writing to system memory (e.g., DDR memory) via a data bus (e.g., system bus or multimedia bus), and each of the depicted counters 104 provides an indication of a number of read/write events that are occurring (e.g., between a hardware device and system memory). Also depicted at the hardware level are a bus quality of service (QoS) component 106, and a memory/bus clock controller 108.

At the kernel level, a collection of n memory-access monitors (“MAMs”) 110 are in communication with a memory/bus frequency control component 112 that is in communication with the bus QoS component 106 and the memory/bus clock controller 108. In the depicted embodiment the memory/bus frequency controller 112 may be realized by components implemented in the kernel (e.g., LINUX kernel), and the memory-access monitors 110 may be realized by additions to the LINUX kernel to effectuate the functions described herein. As depicted, each of the memory-access monitors 110 is in communication with one or more counters 104 to enable the memory-access monitors 110 to configure the counter(s) 104 and to enable the memory-access monitors 110 to receive interrupts from the counter(s) 104. In turn, the memory-access monitors 110 communicate data transfer rate information to the memory/bus frequency controller 112 and in turn, the memory/bus frequency control component controls 112 the bus QoS controller 106 and the memory/bus clock controller 108 (as described further herein) to effectuate the desired bus and/or memory frequencies.

It should be recognized that the depiction of components in FIG. 1 is a logical depiction and is not intended to depict discrete software or hardware components, and in addition, the depicted components in some instances may be separated or combined. For example, the depiction of distributed memory-access components 110 is exemplary only, and in some implementations the memory-access components 110 may be combined into a unitary module. In addition, it should be recognized that each of the depicted counters 104 may represent two or more counters 104, and the counters 104 associated with each hardware device 102 may be distributed about the computing device 100.

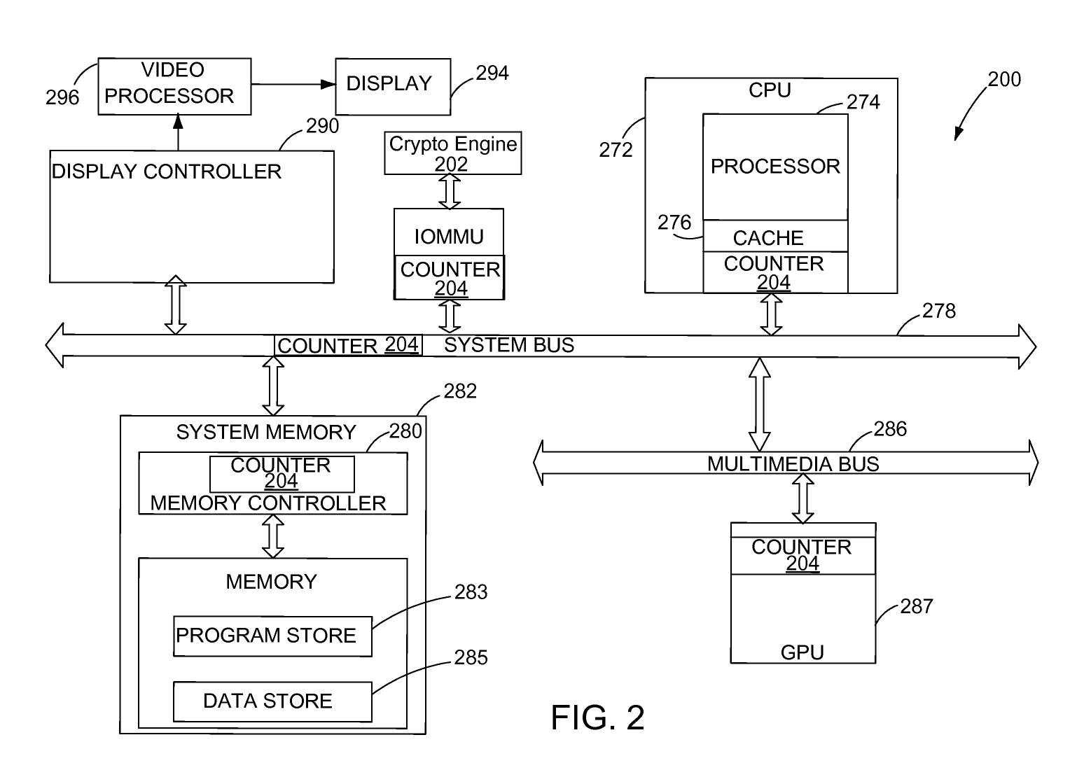

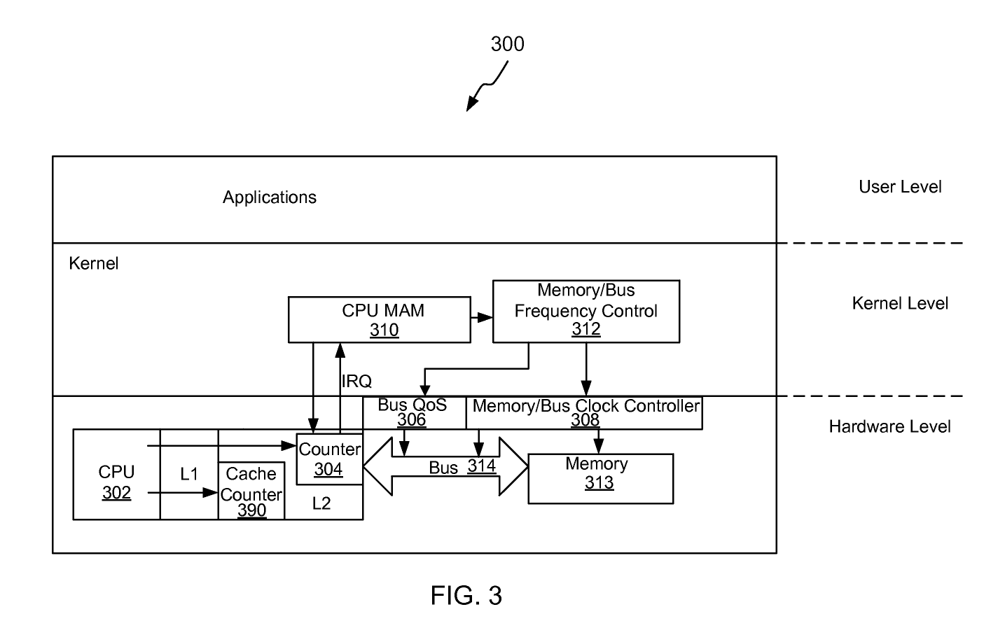

Referring to FIG. 2 for example, shown is a processor-based system 200 that includes a distribution of counters 204 and exemplary hardware devices such as a graphics processing unit (“GPU”) 287, a memory controller 280, a crypto engine 202 (also generally referred to as a hardware device 202), and one or more central processing units (CPUs) 272, each including one or more processors 274. The CPU(s) 272 may have cache memory 276 coupled to the processor(s) 274 for rapid access to temporarily stored data. The CPU(s) 272 is coupled to a system bus 278 and can inter-couple master devices and slave devices included in the processor-based system 270. As is well known, the CPU(s) 272 communicates with these other devices by exchanging address, control, and data information over the system bus 278. For example, the CPU(s) 272 can communicate bus transaction requests to the memory controller 280 as an example of a slave device. In addition to the system bus 278, the processor-based system 200 includes a multimedia bus 286 that is coupled to the GPU 287 hardware device and the system bus 278. Although not illustrated in FIG. 3, multiple system buses 278 could also be provided, wherein each system bus 278 constitutes a different fabric.

As illustrated in FIG. 2, the system 200 may also include a system memory 282 (which can include program store 283 and/or data store 285). Although not depicted, the system 200 may include one or more input devices, one or more output devices, one or more network interface devices, and one or more display controllers. The input device(s) can include any type of input device, including but not limited to input keys, switches, voice processors, etc. The output device(s) can include any type of output device, including but not limited to audio, video, other visual indicators, etc. The network interface device(s) can be any devices configured to allow exchange of data to and from a network. The network can be any type of network, including but not limited to a wired or wireless network, private or public network, a local area network (LAN), a wide local area network (WLAN), and the Internet. The network interface device(s) can be configured to support any type of communication protocol desired.

The CPU 272 may also be configured to access the display controller(s) 290 over the system bus 278 to control information sent to one or more displays 294. The display controller(s) 290 sends information to the display(s) 294 to be displayed via one or more video processors 296, which process the information to be displayed into a format suitable for the display(s) 294. The display(s) 294 can include any type of display, including but not limited to a cathode ray tube (CRT), a liquid crystal display (LCD), a plasma display, etc.

In general, the memory-access monitors 110 in connection with the memory/bus frequency controller 112 allow the frequency of the system bus 278 and/or memory 282 to be dynamically scaled based on the memory access rate—independent of the execution/instruction load on the hardware devices (e.g., crypto engine 202, CPU 272, and GPU 287). As a consequence, when the CPU 272 is performing intensive work that requires little access to memory 282, the memory and/or bus frequencies may be kept low. This is a substantial benefit over prior approaches that adjust the frequency of the memory 282 based on the CPU 272 frequency even if the memory access rate from the CPU 272 is low. The crypto engine 202 generally operates to encrypt and decrypt data without using the CPU 272. It should be recognized that the crypto engine 202 is merely an example of the type hardware device that may be coupled to the system bus 278, but for clarity hardware devices other than the crypto engine 202, CPU 272, and GPU 287 are not depicted in FIG. 2.

Referring next to FIG. 3, it is a block diagram 300 depicting an exemplary embodiment in which read/write events associated with a CPU 302 (also referred to generally as a hardware device 302) are monitored by a counter 304 in connection with a CPU memory access monitor 310 (also more simply referred to herein as a memory access monitor 310). As depicted in the hardware level, the CPU 302 is in communication with system memory 313 (e.g., DDR memory) via a first level cache memory (L1), a second level cache memory (L2), and a system bus 314. Also depicted at the hardware level are a bus quality of service (QoS) component 306, and a memory/bus clock controller 308. As depicted, the L2 memory in this embodiment includes the performance counter 304, and at the kernel level, the memory access monitor 310 is in communication with the performance counter 304 and a memory/bus frequency control component 312 that is in communication with the bus QoS component 306 and the memory/bus clock controller 308.

In this embodiment, the memory/bus frequency control component 312 operates in much the same manner as the memory/bus frequency control component 112 to control the bus QoS 306 and memory/bus clock controllers 308 to effectuate the desired bus and/or memory frequencies. In this embodiment the performance counter 304 in the L2 cache provides an indication of the amount of data that is transferred between the L2 cache memory and system memory 313. One of ordinary skill in the art will appreciate that most L2 cache controllers include performance counters, and the depicted performance counter 304 (also referred to herein as the counter 304) in this embodiment is specifically configured (as discussed further herein) to count the read/write events that occur when data is transferred between the cache memory (L2 memory) and the system memory 313 to determine how much data is transferred between the cache memory and system memory 313.

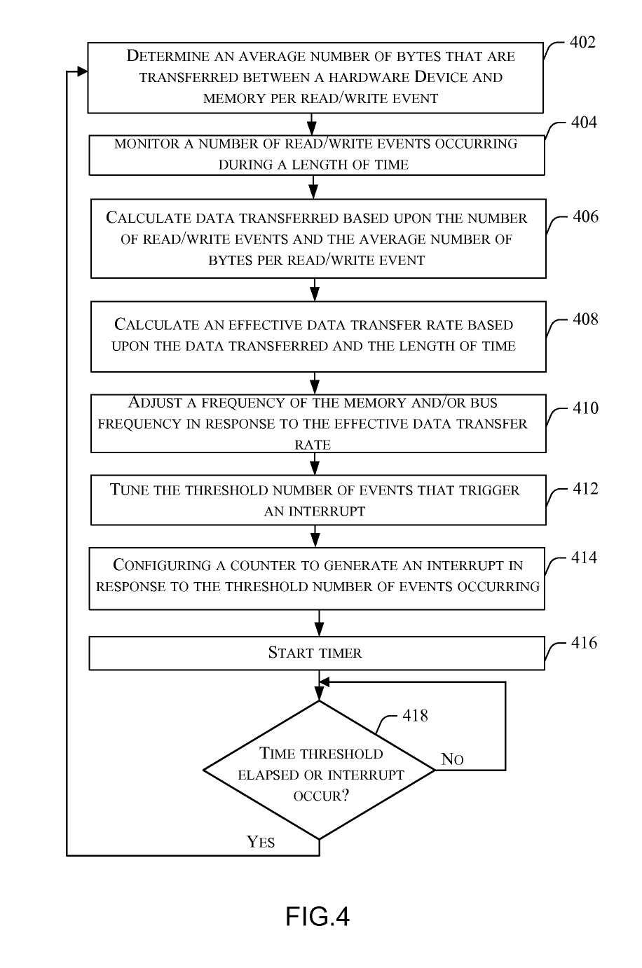

Referring next to FIG. 4, it is a flowchart depicting an exemplary method that may be traversed in connection with the embodiments described herein. As depicted, an average number of bytes that are transferred between a hardware device (e.g., hardware devices 102, 202, 302), and the system memory (e.g., system memory 282, 313) for each read/write event is determined (Block 402), and the number of read/write events occurring during a length of time is monitored to enable the number of bytes that are transferred to be calculated based upon the number of read/write events and the number of bytes per event (Blocks 404 and 406). As depicted, an effective data transfer rate may then be calculated based upon the data transferred and the length of time (Block 408), and a frequency of the memory and/or the bus frequency may be adjusted in response to the effective transfer rate. Thus, the memory frequency may be scaled based on the memory access rate independent of the execution/instruction load on the hardware devices (e.g., CPU 272, 302). As a consequence, when performing hardware device intensive work (e.g., CPU-intensive work) that requires little access to memory, the memory and/or bus frequencies are kept low (e.g., to reduce power utilization).

In the embodiment depicted in FIG. 3, the memory access monitor 310 periodically (every sample period) monitors a value that is output by the performance counter 304 in the L2 cache to determine how many read/write events have happened between each observation of the counter 304. Then, by comparing the number of read/write events to the time elapsed between the two observations, the number of read/write events that occur per second may be calculated. From this information, the total number of bytes transferred may be calculated by multiplying the average number of bytes that are transferred between cache memory and system memory 313 per read/write event times the number of read/write events.

In the embodiment depicted in FIG. 1, each of the plurality of memory access monitors 110 monitors a value (or values) from a corresponding counter 104 (or counters), and the total amount of data transferred by each hardware device 102 may be calculated by each memory access monitor 110. Each memory access monitor 110 may then communicate the bandwith requirements of the hardware device 102 (or hardware devices 102) that it monitors to the memory/bus frequency controller 112. The memory/bus frequency controller 112, in turn, aggregates the data transfer information received from the memory access monitors 110 and adjusts the frequency of the system memory and/or bus frequency based upon the collective outputs of the memory access monitors 110.

Referring again to FIG. 4, a threshold number of events may be calculated that trigger an interrupt (Block 412). In general, it is preferable that an increase in memory read/writes be immediately detected and that the bus and/or memory frequency be quickly adjusted appropriately. In some implementations, the memory access monitor 110, 310 collects historical data from the previous sampling of the counter 104, 204, 304 and dynamically tunes the limit that triggers an interrupt based on the historical data. If the counter counted X events since the previous sample, then setting up the interrupt limit to X (or a lower value) would cause a high probability that the interrupt would be fired again before the next sampling time point. This would result in too many interrupts that would be very close to the next sampling time point and effectively one interrupt per sampling period would occur even if the memory usage didn't change, which would be very inefficient. So, the memory access monitor may set the limit that triggers the interrupt to be X*(1+(tolerance/100)), where X is the number of events counted in the previous sampling window and the tolerance is in terms of a percentage of X. As a consequence, a tolerance of zero would result in the interrupt being set to trigger as soon as X events happen in the future, but a higher tolerance percentage would result in waiting for a few more events to be counted past X before the interrupt is triggered.

As shown in FIG. 4, the counter 104, 204, 304 is then configured to generate an interrupt in response to the threshold number of events occurring (Block 414). Depending upon the hardware that is utilized to realize the computing device 100, the counters 104, 204, 304 may only have interrupts that are sent when an overflow occurs, which is when the counter counts past its maximum limit (e.g., 0xFFFFFFFF in hex for a 32-bit counter) and wraps around to zero. In other words, the counter may not provide interrupts that occur when the counter counts past a particular value.

In many implementations, the counter is configured to start from a maximum value minus a particular number of X read/write events (max value−X) in order for an interrupt (IRQ) to occur when X read/write events have been counted. In this way, when X events occur, the value of the counter becomes the maximum value. Then the next event causes an overflow that in turn will trigger an interrupt to be fired. So, when the interrupt arrives at the memory access monitor 110, 310, it indicates that the limit of X events has been exceeded. As a consequence, when an interrupt is needed when Y bytes of data have been transferred since the last observation, the value of X may be selected so that X=Y divided by the average number of bytes transferred per event, and the counter is configured to start counting from the maximum value minus the computed value of X (max value−computed value of X). In this way, the counter overflow interrupts that are typically provided by the counter may be re-purposed as “usage exceeded” interrupts.

As shown, in connection with a frequency adjustment a timer is started (Block 416), and until either a time threshold is met or an interrupt occurs (Block 418), the bandwidth request sent to the memory/bus frequency controller 112 remains the same. But if the time threshold is met or an interrupt occurs (Block 418), the method described with reference to Blocks 402 through 418 is repeated. It should be recognized, however, that the average quantity of data transferred per read/write event by a hardware device at Block 402 need not be calculated during each iteration (of Blocks 402 through 418).

When an interrupt occurs (e.g., when the number of read/write events have crossed a preset threshold), the memory access monitor 110, 310 may check the current time to determine how much time has elapsed since the most recent prior time the counter was set up, and then the memory access monitor 110, 310 uses this elapsed time (which can be different from the periodic sample period) in connection with the number of events that were counted to recalculate the effective data transfer rate that triggered the interrupt to fire (Block 408). The frequency of the memory and/or frequency of the bus are then adjusted through the memory/bus frequency controller 112 in response to the new effective data transfer rate to accommodate the increase in memory read/write activity (Block 410).

In some implementations, a “guard band” may be added to the measured memory read/write data rate before determining the frequency the system memory 282, 313 or bus 278, 314 should be adjusted to at Block 410. If for example, it is determined that X MB/s of data have been transferred, then figuring out the memory/bus frequency that provides the best performance/power ratio is not sufficient. If only the performance-to-power ratio is considered, then when the memory usage increases in the future, there might not be enough time to react to increase the memory frequency before performance starts suffering drastically. In other words, a sufficient amount of time must be available to react in order to increase the system memory and or bus frequencies when an increase in memory usage is detected. As a consequence, in many embodiments an additional “guard band” value is added to the calculated data rate X and this new increased data rate (X+“guard band value”) is used to set the new memory frequency, but the interrupt will fire when the lower value (X) data transfer rate is exceeded. So, when X MB/s of data transfer rate is exceeded, there is still time to increase the memory frequency before the performance is negatively affected. In variations of these embodiments, the guard band value is set as a percentage of the measured value X.

Another aspect that may be implemented is a tunable parameter (RW_Percent)(also referred to as IO_percent) to account for the percentage of time that the CPU or other hardware device is actually accessing the memory. The counters 104, 204, 304 may indicate that, for example, a hardware device 102, 202, 302 is transferring X MB over a second, but in reality, the hardware device 102, 202, 302 may only use a fraction of any given second to transfer data. For example, hardware devices very often do a lot of other work besides work that requires read/write access. By having the RW_Percent tunable parameter that denotes the percentage of time the hardware device 102, 202, 302 spends doing memory access, it is possible to calculate a more appropriate bandwidth and QoS/latency requirements that the need to be sent to the memory and/or bus frequency controller 112.

Assuming, for example, that the memory can transfer D bytes for every 1 Hz of the memory frequency, and that X MB/s was the data transfer rate based on the last sampling, then a straightforward way to pick the memory frequency is X/D Hz. But this approach is not utilized in many implementations because doing so would mean that the memory is only fast enough to allow the hardware device to transfer X MB in a second. That would mean that if the hardware device tries again to transfer X MB in a second, it would only have enough time to transfer X MB in that second would have no time left to do any other work. Because hardware devices (e.g., a CPU) do a lot of other work that does not require data transfer (i.e., memory read/write is only a fraction of work that hardware devices complete), the minimum memory frequency (minimum_DDR_freq) is instead computed as (X*100/RW_Percent)/D.

In some embodiments, the RW_Percent value is statically defined to be a value that generally provides power savings without sacrificing hardware device performance. For example, without limitation, static RW_Percent values may be 10, 15, 20, 30, 40, or 50 percent, but other values may certainly be utilized. In other embodiments, the RW_Percent value may be dynamically calculated to tailor the RW_Percent value to the extent to which the corresponding hardware device 102, 202, 302 is effectuating memory-intensive or hardware-device-intensive operations. If the workload on the hardware device is memory intensive, for example, the RW_Percent value may be increased, and if the workload is not memory intensive the RW_Percent value may be decreased or vice versa.

For hardware devices 102, 202, 303 that are coupled to cache memory, the determination of whether the workload on a hardware device is system memory intensive may be made my comparing the number of requests that are made to cache memory versus the number of requests that go to system memory. Referring to FIG. 3, for example, a cache counter 390 may be utilized to count a number of requests that are made to L2 cache memory, and a ratio of L2 requests (counted by the cache counter 390) to system memory requests (counted by the counter 304) may be utilized as an indicator of system memory utilization. As a consequence, a low ratio of L2-requests to system-memory requests is indicative of a high level of system-memory-related workload and a high ratio is indicative of a low level of system-memory-related workload.

In some embodiments, a user may define upper and lower RW_percent values, and based upon the ratio of cache-memory requests to system-memory requests, a RW_percent value between the upper and lower values may be selected. For example, a user may establish 50% and 10% values as upper and lower RW_percent values, respectively. Thus, if the ratio of cache-memory requests to system-memory requests is relatively low, the RW_percent value may be a value that is close or equal to 50%. And if the ratio of cache-memory requests to system-memory requests is relatively high, the RW_Percent value may be a value that is close to 10%. By way of further example, if the number of cache-memory requests is about the same as the number of system-memory requests (so the ratio is close to one) the RW_percent value may be set to about 30%. In other modes of operation, the RW_percent value may be calculated in the opposite manner. In other words, if the ratio of cache-memory requests to system-memory requests is relatively low, the RW_percent value may be a lower value (e.g., close or equal to 10%). And if the ratio of cache-memory requests to system-memory requests is relatively high, the RW_Percent value may be set to a relatively high value (e.g., close to 50%).

Another aspect that may be effectuated by the memory/bus frequency control component 112 is voting for a minimum memory frequency and also voting on aggregated bandwidth. Most operating systems provide an interface to vote for the minimum memory frequency (Hz) and also allow voting for aggregated bandwidth (MB/s) needed by a client (e.g., CPU, GPU, display, etc). Operating systems typically add up the aggregate bandwidth votes from multiple clients and then compute the memory frequency needed for the bandwidth votes (referred to herein as DDR_BW_freq) by setting DDR_BW_freq equal to the sum of all aggregated bandwidth votes from the clients divided by D, where D is the number of bytes the memory can transfer for each Hz. The typical operating system then picks the biggest value among this computed DDR_BW_freq and the “minimum DDR freq” votes made by all the clients.

In many embodiments, both voting for the minimum_DDR_freq (as discussed above) and voting for an aggregated bandwidth votes of Y MB/s are carried out, where Y is the measured memory access rate+guard band. The reason for doing this is because if the DDR_BW_freq (based on all the bandwidth votes from other clients) is already greater than the minimum_DDR_freq voted for the hardware device, then it is not sufficient to leave the memory at that frequency. Instead, the DDR frequency needs to be increased further to accommodate for the Y MB/s of additional memory access that's going to come from the hardware device without starving the other clients of the memory. As a consequence, the bus monitor in many implementations votes on a minimum memory frequency to guarantee low latency for the memory access coming from the hardware device, but also votes on aggregated BW to make sure the hardware device doesn't starve other memory clients that might also be using the memory.

In some embodiments, a decay rate percentage may be used to calculate an effective memory data transfer rate. Dropping the memory frequency as soon as the memory data transfer rate starts decreasing can lead to a lot of repetitive increases and decreases (e.g., “ping-pong” type increases and decreases) of the memory frequency due to bursts of memory access from the hardware device. To avoid this, a cumulative decay rate percentage may be used, that in effect, determines how fast history/previous measurements are “forgotten.” When the memory data transfer rate has changed in a particular sample compared to the previous one, the “effective” memory data transfer rate (referred to herein as eff_DDR_MBps) is computed as: eff_DDR_MBps=eff_DDR_MBps*(1−(decay_rate_precent/100))+measured DDR transfer rate*(decay_rate_percent/100). The eff_DDR_MBps is then used to do all the calculations mentioned above. Thus, a decay rate percent of 100 would mean that history is completely ignored whereas a decay rate percent of 0 would mean that the effective memory transfer rate would never drop below the historical maximum measured value. In some implementations, a decay rate percentage is utilized only when the memory data transfer rate has decreased, and if the memory data transfer rate has increased, the new effective data transfer rate may be used.

Yet another aspect that is included in many embodiments is a combined polling and interrupt based mechanism. More specifically, the use of interrupts (to quickly react to a rapid increase in memory access rate) is combined with a periodic polling based mechanism (to react at a relatively more leisurely pace when the memory access rate decreases or only increases slowly). This provides a beneficial mechanism to keep the overhead of running the algorithm to a low and reasonable level.

All the above detailed aspects allow dynamically scaling the memory frequency based on the hardware device's memory access rate independent of the execution/instruction load on the hardware device. So, when performing hardware-device-intensive work that requires little access to memory, the memory and/or bus frequencies are kept low.

It should be recognized that the use of performance counters in the L2 cache is not required in all embodiments, and that any counter that is disposed to count memory access from a particular master and has interrupt capabilities may be utilized. Some embodiments may even work without using an interrupt if the counter doesn't have that capability, but at the cost of being less effective than an embodiment that could use an interrupt.

Those of skill in the art would further appreciate that the various illustrative logical blocks, modules, circuits, and algorithms described in connection with the embodiments disclosed herein may be implemented as electronic hardware, instructions stored in memory or in another computer-readable medium and executed by a processor or other processing device, or combinations of both. The devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a processor, a DSP, an Application Specific Integrated Circuit (ASIC), an FPGA or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The embodiments disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined. It is to be understood that the operational steps illustrated in the flow chart diagrams may be subject to numerous different modifications as will be readily apparent to one of skill in the art. Those of skill in the art would also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A method for controlling frequency of at least one of system memory and a system bus on a computing device, the method comprising:
monitoring a number of read/write events occurring between a hardware device and the system memory via the system bus during a length of time with a performance counter;
calculating an effective data transfer rate based upon an amount of data transferred between the hardware device and the system memory in connection with the read/write events during the length of time;
periodically adjusting a frequency of at least one of the system memory and the system bus based upon the effective data transfer rate;
dynamically tuning a threshold number of events that trigger an interrupt based upon a history of the number of read/write events;
receiving the interrupt from the performance counter when the threshold number of read/write events occur; and
adjusting the frequency of at least one of the system memory and the system bus when the interrupt occurs.

2. The method of claim 1 including monitoring a plurality of performance counters, each of the performance counters providing an output indicative of a number of read/write events that occur when data is transferred between at least one hardware device and the system memory.

3. The method of claim 2, wherein one or more of the plurality of performance counters each monitors read/write events associated with a plurality of hardware devices.

4. The method of claim 2, including aggregating data transfer information from the plurality of performance counters and adjusting the frequency based upon aggregated data transfer information.

5. The method of claim 1, wherein calculating the effective data transfer rate includes utilizing a decay rate percentage that is based upon previous changes in the effective data transfer rate over time.

6. The method of claim 1, wherein calculating the effective data transfer rate includes adding a guard band value to the effective data transfer rate.

7. The method of claim 1, including:
establishing an RW_Percent value to define bandwidth requirements for the system memory; and
utilizing the RW_Percent value in connection with adjusting the frequency of the system memory.

8. The method of claim 7, wherein the RW_Percent value is dynamically calculated based upon the extent to which the hardware device is utilizing the system memory in connection with its operations.

9. The method of claim 8, wherein the RW_Percent value is dynamically calculated by calculating a ratio of a number of read/write requests that are made to cache memory to a number of read/write requests that are made from cache memory to system memory.

10. The method of claim 1 including reconfiguring the performance counter so an overflow interrupt of the performance counter operates as the interrupt that occurs when the threshold number of read/write events occur.

11. A computing device comprising:
a hardware device;
cache memory coupled to the hardware device;
system memory;
a system bus to couple the system memory to the cache memory;
means for monitoring a number of read/write events occurring between a hardware device and the system memory via the system bus during a length of time with a performance counter;
means for calculating an effective data transfer rate based upon an amount of data transferred between the hardware device and the system memory in connection with the read/write events during the length of time;
means for periodically adjusting a frequency of at least one of the system memory and the system bus based upon the effective data transfer rate;
means for dynamically tuning a threshold number of events that trigger an interrupt based upon a history of the number of read/write events;
means for receiving the interrupt from the performance counter when the threshold number of read/write events occur; and
means for adjusting the frequency of at least one of the system memory and the system bus when the interrupt occurs.

12. The computing device of claim 11 including means for monitoring a plurality of performance counters, each of the performance counters providing an output indicative of a number of read/write events that occur when data is transferred between at least one hardware device and the system memory.

13. The computing device of claim 12, wherein one or more of the plurality of performance counters each monitors read/write events associated with a plurality of hardware devices.

14. The computing device of claim 12, including means for aggregating data transfer information from the plurality of performance counters and means for adjusting the frequency based upon aggregated data transfer information.

15. The computing device of claim 11 including means for reconfiguring the performance counter so an overflow interrupt of the performance counter operates as the interrupt that occurs when the threshold number of read/write events occur.

16. A non-transitory, tangible processor readable storage medium, encoded with processor readable instructions to perform a method for controlling frequency of at least one of system memory and a system bus on a computing device, the method comprising:
monitoring a number of read/write events occurring between a hardware device and the system memory via the system bus during a length of time with a performance counter;
calculating an effective data transfer rate based upon an amount of data transferred between the hardware device and the system memory in connection with the read/write events during the length of time;
periodically adjusting a frequency of at least one of the system memory and the system bus based upon the effective data transfer rate;
dynamically tuning a threshold number of events that trigger an interrupt based upon a history of the number of read/write events;
receiving the interrupt from the performance counter when the threshold number of read/write events occur; and
adjusting the frequency of at least one of the system memory and the system bus when the interrupt occurs.

17. The non-transitory, tangible processor readable storage medium of claim 16, the method including monitoring a plurality of performance counters, each of the performance counters providing an output indicative of a number of read/write events that occur when data is transferred between at least one hardware device and the system memory.

18. The non-transitory, tangible processor readable storage medium of claim 17, wherein one or more of the plurality of performance counters each monitors read/write events associated with a plurality of hardware devices.

19. The non-transitory, tangible processor readable storage medium of claim 17, the method including aggregating data transfer information from the plurality of performance counters and adjusting the frequency based upon aggregated data transfer information.

20. The non-transitory, tangible processor readable storage medium of claim 16, the method including reconfiguring the performance counter so an overflow interrupt of the performance counter operates as the interrupt that occurs when the threshold number of read/write events occur.
